(19) United States
(12) Patent Application Publication
(10) Pub. No.: US 2009/0030832 A1
(43) Pub. Date: Jan. 29, 2009

(54) CREDIT EVALUATION SYSTEM AND METHOD FOR NETWORK EFFECT CREDIT EXTENSION

(76) Inventor: Yung-Sung CHIEN, Taipei (TW)

Correspondence Address: SINORICA, LLC, 528 FALLSGROVE DRIVE, ROCKVILLE, MD, 20850, US

(21) Appl. No.: 12/178,720

(22) Filed: Jul. 24, 2008

(30) Foreign Application Priority Data
Jul. 26, 2007 (TW) 096127234

(51) Int. Cl. G06Q 40/00; G06Q 20/00; G06Q 30/00

(52) U.S. Cl. 705/37; 705/38; 705/35

(57) ABSTRACT

Disclosed is a credit evaluation system and method for network effect credit extension that is applied in financial and electronic business fields. The major objective is to construct a credit evaluation system by employing the Internet technology, so that people in need of a loan may obtain credit amount faster than those utilizing an existing credit evaluation method without having to reduce the credit evaluation standard.

In the implementation of a credit evaluation system for network effect credit extension, the system proceeds with the application of credit extension portfolio for member desiring to be a credit extension granting member and a credit extension receiving member, calculation, granting, real-time control and supervision of an overall credit extension amount, data updating, and liquidation of credit extension amounts; and finally calculating, collecting, and issuing a credit extension service charge and credit extension guarantee revenue, thus realizing a credit extension credit evaluation method.

### BACKGROUND OF THE INVENTION

1. Field of the Invention

The present invention relates to a credit evaluation system and method in providing timely credit extension for its members to replace the manual credit evaluation of conventional financing by making use of the decentralization of the Internet, network effect, and the efficiency of direct financing. In the credit evaluation system of the present invention, the Internet is utilized to construct a credit evaluation system for credit extension, thus through the utilization of a credit extension portfolio module, a real-time risk control and management module, combined with the concept of network effect and capital flow process, such that credit extension receiving member may get the loan required without having to go through the tedious and time-consuming joint credit evaluation system of a commercial bank.

2. The Prior Arts

The deposit-and-loan business has long been a major source of profit for a bank, and the determination of a bank as to whether to grant a loan to a customer is achieved through credit evaluation. In general, in the process flow of credit evaluation, firstly, the related data of a customer is examined carefully by the person in charge of credit evaluation in a bank, and the customer must go to a counter of a bank personally to finish the related procedures required; then, the related information of the customer is uploaded through an inquiry system of a Joint Credit Inquiry Center (JCIC); and subsequently, upon transferred back to the bank, data verification has to be done and then the data is uploaded to the pertinent superior of the bank for further verification and approval, as such the credit evaluation operation is carried out repeatedly, hereby obtaining a credit evaluation report as required. Therefore, the major problem of the conventional credit evaluation operation process is that excessive work is required, thus resulting in overly high credit evaluation cost, meanwhile, the overly long operation time required tends to create gaps or loop holes in credit evaluation process, hereby resulting in huge loss of overly due loans. Therefore, the problem of how to create a complete and integral credit evaluation system that can meet and fulfill the requirements of financial operations of network-oriented age of science and technology, is a most important task that must be solved in this financial field.

With the rapid progress and development of the modern age, and the rapid advancement of the Internet technology, the various effects generated by the Internet have influenced the modern time financial industry tremendously. Up to the present time, various banks have established electronic (e)-banking to cope with the impact of the Internet effect, so as to replace the conventional deposit-and-loan business and credit evaluation operations. However, the present day electronic (e)-banking is not capable of achieving full-fledged credit evaluation operations and/or deposit-and-loan business entirely on a network platform. Even though the Joint Credit Evaluation Inquiry System of the Joint Credit Evaluation Center is a creation of the age of electronic (e)-network, yet it is still not capable of achieving a full-fledged network operation mechanism. Therefore, the purpose and objective of the present invention is to establish a credit evaluation system for full-fledged network credit extension by making use of network effect.

In this connection, referring to U.S. Pat. No. 63,885,594B1 “Method and computer network for coordinating a loan over the Internet,” that is used to provide a method for the user to rapidly apply for higher credit amount from a bank or other capital deposit-and-loan institutions. The method consists of the steps of selecting by an applicant on a web-page interface the item to be applied for according to the purpose of the loan (such as, house loan, car loan, or tuition loan); next, filling in by an applicant the related application data; then, up-loading the data of the applicant to an eligible deposit-and-loan financial institutions, and then transferring it to a credit evaluation institution (such as, a Joint Credit Evaluation Center), for proceeding with more detailed data selection and screening for determining if the application should be approved. Compared with conventional credit evaluation means, though this patent may be utilized to save quite a lot of time spent on loan application through computerized screening and selection process, however, it still has to go through conventional credit evaluation institutions, such as Joint Credit Evaluation Center to complete credit evaluation process. Hence, this patent is still not capable of eliminating the limits and restrictions of conventional credit evaluation system.

Moreover, in U.S. Pat. No. 7,133,935B2 “System and method for real-time electronic inquiry, delivery and reporting of credit information,” the credit data of a loan applicant is transferred in 128SSL enciphered manner, thus preventing the private data of a loan applicant from leakage. Meanwhile, in this patent, credit evaluation application data is transferred through the Internet, then the credit evaluation results are transferred back from credit evaluation institutions in a simplified and uniform format. The advantage of this patent is that, security enciphering is utilized to protect the privacy of loan applicants, and network is used to save the processing time of the credit evaluation operation. However, in this patent, credit data of a loan applicant still has to be obtained through a credit evaluation institution; thus even the security enciphering measures are taken, yet the restriction of a centralized credit evaluation institution still can not be avoided, thus the patent is not capable of achieving a direct credit evaluation mode based on a network. Therefore, this technique does indeed have its limitations.

In addition, in U.S. Pat. No. 006,088,686A “System and method to perform on-line credit reviews and approvals,” the system and method is utilized to process examination of related data, evaluation of credit status, and examination of transactions with financial institutions for the loan bearer customer by computer technology. The application of this patent is based on the powerful calculation capabilities of a computer to replace functions of conventional credit evaluation institution. However, that patent may be only used to provide static credit status report and credit evaluation results for a customer. Yet it can not be used to make adroit manipulation of the credit amount of that customer, or even to supplement it with a dynamic effect analysis. In other words, though that patent is feasible, yet its prospect of further development is not very satisfactory.

Though, in the two above-mentioned patents, network is utilized as a means to provide a method of expediting credit evaluation operations, yet it still has to go through the examination of conventional joint credit evaluation institutions, thus resulting in the consequence that it can not realize credit evaluation operation through direct financial means. In addition, in the last patent mentioned above, though computers are utilized enormously to realize credit evaluation operations; however, only static credit evaluation report can be obtained. Therefore, due to the above-mentioned shortcomings and restrictions of prior art, the present invention discloses a creative system and method, wherein network effect is utilized to eliminate the restriction of highly centralized conventional credit evaluation. Moreover, the concept of credit extension is proposed and introduced, thus creating a network-based credit evaluation system of credit extension.

### SUMMARY OF THE INVENTION

In order to overcome the problem and restriction of the prior art, the present invention provides a credit evaluation system and method for network effect credit extension having the following major objectives:

1. Replacing the manual credit evaluation of conventional financial institutions:

In the conventional credit evaluation process, the bank requests and obtains from the Joint Credit Evaluation Center the transaction records of an applicant vis-a-vis the transaction bank based on the basic personal data of a loan applicant. In addition, with regard to a guarantor, he/she must likewise be subject to the same credit evaluation process of a bank. In such a credit evaluation operation process flow, tremendous amount of credit evaluation time and cost are required. In the present invention, a set of devices of an electronic commercial system is constructed based on the Internet, so that a credit extension receiving member may utilize this system to achieve the purpose of credit evaluation, or the guarantor may obtain the qualification of credit extension granting member without having to subject to the restrictions of the existing credit evaluation operation that both the applicant and guarantor must pay a visit to the bank personally, and have to go through the joint credit evaluation operations, hereby saving the time spent thereon and also the inconvenience.

2. Achieving credit extension objective through utilizing network effect:

Under the influence of network effect, and due to the convenience and instantaneity of network information, the system of the present invention may be utilized to calculate the credit extension amount granted to its members, and then extend the amount to its credit extension receiving member, hereby forming a credit extension network, and achieving the objective of creating a credit evaluation system for network credit extension.

3. Achieving decentralization of credit evaluation systems through the characteristics of the Internet:

Conventionally, the credit evaluation mechanism of the entire financial industry is highly centralized; namely, most of the credit evaluation operation is carried out according to the institution of a centralized department. However, the quality of the network is that it does not have a definite center, or the limitation of a boundary. Therefore, the objective of the present invention lies in employing the characteristics of a de-centered network, thus creating an effect of credit extension and a credit evaluation system of direct finance by making use of network technology.

4. Creating guarantee revenue for credit extension granting member:

In a traditional society, a person was liable to act as a guarantor of, for example, a loan applicant without charging any fees for being his/her friends or relatives. However, the objective of the present invention is to create a brand new credit evaluation operation system, and supplementing it with concepts of credit extension based on network technology, so that in the system of the present invention, a credit extension granting member will obtain guarantee revenue for being guarantor of the credit extension given to a credit extension receiving member.

5. Establishing a dynamic risk control and management system by making use of the efficiency of the Internet:

The credit status, credit evaluation, and credit amount of both the credit extension receiving member and credit extension granting member will be changed according to the time and the environment of macro-economy. In the present invention, a set of real-time dynamic risk control & management system is established on the Internet, to replace the static credit evaluation process flows and operation systems of conventional banks and/or other financial institutions, hereby increasing the flexibility of the credit extension members in the credit evaluation operation process flow.

6. Miniaturizing the conventional credit evaluation system:

Since for quite a long time, the credit evaluation operation of banks or other financial institutions are based on centralized credit evaluation operation mechanisms, such as the Joint Credit Evaluation Inquiry System of Joint Credit Evaluation Center. In the present invention, the conventional credit evaluation operation system is divided and miniaturized by making use of network effect, so that respective participant of the platform each forms a credit extension network, thus achieving a network-based credit extension credit evaluation system.

7. Providing a real-time credit evaluation operation:

In the present invention, the essence of the network effect is that the operations on network are exempt from the limitations of time and space. In general, credit evaluation operation does have time limitation and can not be carried out any time and any place by user's choice, and it must likewise go through the joint credit evaluation center to finish the operation processes. However, the present invention does indeed reflect the functions and trends of network technology, so that members and the credit extension credit evaluation system may contact directly through the operation of network and platform system, hereby eliminating the time and space limitations of conventional credit evaluation operation to realize an invention of real-time credit evaluation operation.

To achieve the above-mentioned objective, the present invention provides a credit evaluation system for network-effect credit extension built in a capital transaction platform. The system of the present invention is provided with a management server used to connect users outside the system through a user interface by means of the Internet, wired communication devices, wireless communication devices, etc. The management server is used to receive the information (such as that related to loan application, amount calculation, collateral provision, etc.) provided by user, and then the information received is turned over immediately to various modules for proceeding with analysis, calculation, and matching, and the results of operations of various modules are stored into a database for access by other modules, management servers and users. The system of the present invention further includes the following modules:

A credit extension portfolio application module: this module is used for more than two users applying to the system for creating credit extension portfolio through a user interface. This module is used to analyze and compare data of applicants, thus verifying whether to approve establishing a credit extension portfolio;

A credit extension amount calculation and granting module: upon creating the credit extension portfolio, this module is utilized to calculate a credit extension amount of an applicant desiring to be a credit extension granting member, and moreover, to calculate the increased collateral amount of that member. In case that member accepts said calculation results, then this module proceeds with granting such a credit extension amount to that member;

A risk real-time control & management module: this module is used to fetch the total credit extension amount data obtained through credit extension amount calculation and that calculated for the granting module, compare the personal data of said credit extension granting member, the accumulated credit extension amount in the platform, the status of collateral, thus being able to update the total credit extension amount of a credit extension granting member in a real-time manner.

A credit extension amount liquidation module: the data relating to the exchange status of amounts between a credit extension granting member and a credit extension receiving member is a real-time data. In the present invention, this module is used to liquidate the credit extension amount data of both sides, hereby checking and verifying the variations of credit extension amounts in a real-time manner;

A credit extension revenue calculation & issuing module: this module is used to calculate the credit extension service charge that a credit extension receiving member should pay the system, and credit extension guarantee revenue that a credit extension receiving member should pay a credit extension granting member, and then proceed with the collecting and issuing of the charge and revenue.

In the present invention, a credit evaluation method for network effect credit extension is provided to execute the above-mentioned system. This method includes the steps of: accepting the applications of creating a credit extension portfolio of an applicant desiring to be a credit extension granting member and an applicant desiring to be a credit extension receiving member; calculating, granting, real-time monitoring and controlling, and data updating of the total credit extension amount; and calculating, collecting and issuing credit extension service charge and credit extension guarantee revenue, thus realizing the system of the present invention.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of credit evaluation system and method for network effect credit extension system according to an embodiment of the present invention;

FIG. 2 is a flowchart of the steps of a method for creating a credit extension portfolio according to an embodiment of the present invention; and

FIG. 3 is a flowchart of the steps of collecting and issuing credit extension portfolio service charge and credit extension guarantee revenue according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

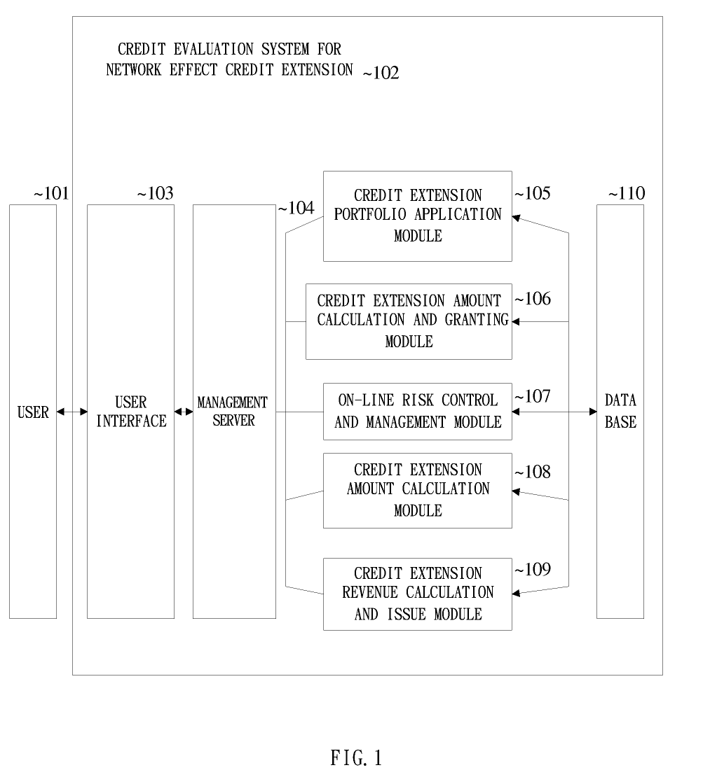

Firstly, referring to FIG. 1 for a schematic diagram of a credit evaluation system for network effect credit extension according to an embodiment of the present invention. As shown in FIG. 1, a system 102 is provided with a management server 104, and a user 101 is connected to the management server 104 via a user interface 103 through network, wired, and wireless communication means by making use of computer, handset, and personal digital assistant (PDA); meanwhile, the management server may exchange messages with members on-line safely through communication network, wired communication device, wireless communication device; moreover, the management server may further be connected to a database 110 and various modules, so that data, messages and results are stored into the related database respectively. The credit evaluation system for network effect credit extension further includes the following modules:

A credit extension portfolio application module 105: this module is used for more than two users applying to the system for creating credit extension portfolio through a user interface 103. This module is used to analyze and compare data of applicants, thus verifying whether to approve establishing a credit extension portfolio;

A credit extension amount calculation and granting module 106: upon creating a credit extension portfolio, this module is utilized to calculate a credit extension amount of the applicant desiring to be a credit extension granting member, and also calculate the increased collateral amount of that member, and moreover, calculate the overall credit extension amount for that member. In case that member accepts that calculation results, then this module proceeds with granting such a credit extension amount to that member.

A risk real-time control & management module 107: this module is used to fetch the total credit extension amount data obtained through credit extension amount calculation and that calculated for the granting module 106, compare the personal data of that credit extension granting member, the accumulated credit extension amount in the platform, the status of collateral, thus being able to adjust and update the overall credit extension amount of a credit extension granting member in a real-time manner.

A credit extension amount liquidation module 108: the data relating to the credit extension amount exchange status between a credit extension granting member and a credit extension receiving member is a real-time data. In the present invention, this module is used to liquidate the credit extension amounts of both sides, hereby checking and verifying the credit extension amount exchange conditions in a real-time manner, and store the results back to database 110, for fetching by management server, other modules, and users.

A credit extension revenue calculation & issuing module 109: this module is used to calculate the credit extension portfolio service charge that a credit extension receiving member should pay the system, and a credit extension guarantee revenue that a credit extension receiving member should pay a credit extension granting member, and then proceed with the collecting and issuing of the charge and revenue.

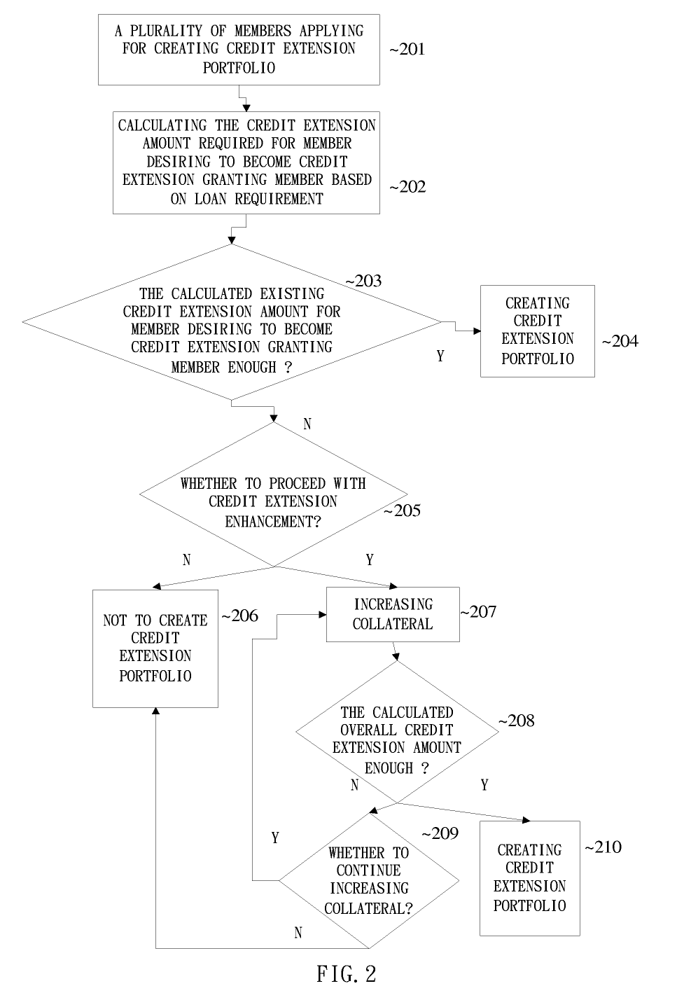

Subsequently, referring to FIG. 2 for a flowchart of the steps of a method for creating a credit extension portfolio according to an embodiment of the present invention. As shown in FIG. 2, the method consists of the following steps of: applying jointly for creating a credit extension portfolio by a user desiring to obtain credit extension amount (namely, a credit extension receiving member), and another user willing to provide credit extension amount (namely, a credit extension granting member) (step 201); next, calculating by the system the credit extension amount required based on the loan requirement of the user desiring to obtain that credit extension amount (step 202); subsequently, calculating by the system the existing credit extension amount of a member desiring to be a credit extension granting member (step 203), herein a credit extension amount calculation and granting module 106 fetches from database 110 the capital data and credit evaluation data of that member to determine its original credit amount, and to this amount is added the deposit amount of that member in a capital transaction platform, thus figuring out its credit extension amount; in case that this credit extension amount is able to meet the requirement of the user desiring to be a credit extension receiving member, then creating a credit extension portfolio (step 204), otherwise, the system inquiring that if the user desiring to be a credit extension granting member is willing to proceed with credit extension enhancement (step 205), if the answer being negative, then a credit extension portfolio can not be created (step 206), otherwise, that member has to increase the collateral (step 207), and a credit extension amount calculation and granting module 106 of the system proceeds with calculation of an overall credit extension amount (namely, the sum of the credit amount of that member, platform deposit amount, and collateral amount) (step 208), in case that this overall credit extension amount is able to meet the requirement of the user desiring to be a credit extension receiving member, then creating a credit extension portfolio (step 210), otherwise, the user desiring to be the credit extension granting member may select whether to continue increasing collateral (step 209), in case that the answer is positive (step 207), then continue to proceed with calculation (step 208), otherwise, that credit extension portfolio still can not be formed (step 206).

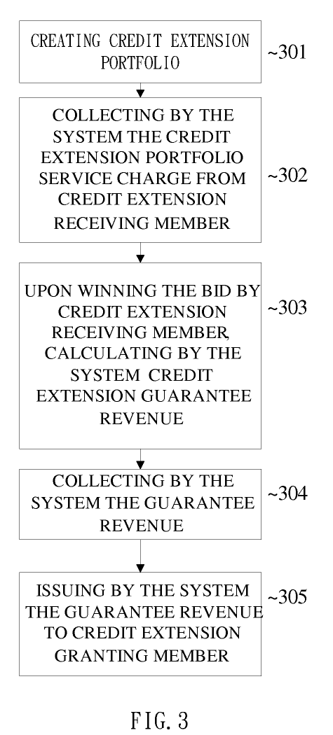

Furthermore, referring to FIG. 3 for a flowchart of the steps of collecting and issuing credit extension portfolio service charge and credit extension guarantee revenue according to an embodiment of the present invention. As shown in FIG. 3, upon establishing a credit extension portfolio (step 301), a credit extension revenue calculation & issuing module 109 of the system proceeds immediately with calculating the credit extension portfolio service charge that the credit extension receiving member must pay the system, and collecting the charge from that member (step 302). Upon successfully winning the bidding and obtaining the loan applied by the credit extension receiving member, the credit extension revenue calculation & issuing module 109 calculates a credit extension guarantee revenue that the credit extension receiving member must pay the credit extension granting member (step 303), and then the system proceeds with collecting that revenue from that credit extension receiving member (step 304), and issues that revenue to that credit extension granting member (step 305).

In the following, two embodiments are provided in describing the implementation of the credit evaluation system and method of the present invention.

### Embodiment 1

In this embodiment, the case of a certain John is taken as an example to facilitate explanation. While he was young, John was a person of rather uncertain character and disposition, and he changed jobs frequently for reasons of not compatible with his character. At the age of 31, he had the opportunity by chance in personally comprehending the glassware manufacturing, and he has been deeply absorbed in it ever since. In spite of the fact of having to endure long period of the heat of high temperature during the manufacturing process, he participated once and once again in the research and production sessions, just for enjoying the feeling of self-dedication and detachedness from the world in this creative process, and a strong feeling of achievement for being praised by the teacher upon completion of producing a piece of product. In order to wholly devoted to learning the glassware manufacturing, John intends to quit his present job and practices his skills under the tutorship of a master. However, for being an apprentice, his monthly income is merely around NT20,000, and upon reviewing his monthly income & expense situations and finding out that in case that he lives on the meager salary of an apprentice, the amount left for food and meals will be very much limited after deducting house rental of around NT 8,000, and electricity and traffic expenses. And this is partly due to his high job changing frequency, so that his salary level has not increased proportionally to his working years. As such, right now, there is no sufficient deposit that can be used to support him in pursuing his life time goal obtained only after painstaking search. Facing such an awkward situation, John has the intention of turning to the bank for a no-collateral loan of credit card that has a recycling interest rate as high as 19.71%, yet he worries about the result that he will eventually become a slave of credit card debt.

Having no other alternatives, John is obliged to turning to his elder brother Henry for help. Henry is of a very stable character and disposition, and he works in an enterprise as a medium level executive. But Henry is strict in handling affairs, and especially in his attitude to John, thus he is quite disappointed about John for having achieved nothing in his life, so they have not got in touch for quite a long time. However, since this time John has made up his mind to dedicate himself to the manufacturing of glass ware in spite of the hardship in this process; that means John has changed a lot, so his elder brother Henry is willing to help at this time. Yet, Henry has the heavy burden of housing loan and also he has to pay for the tuitions of his two sons and two daughters, so in fact there is no idle money left for him to help John. In addition, elder brother Henry has high expectations for John, thus he is of the opinion that he should not support John financially directly, for John is a grown-up person of over 30 years of age, otherwise, John may not care about what might happen to him in the future, and might give things up again easily. While he is in trouble finding a proper way to help John, he suddenly remembers that last year he joined in a network collective-mutual-loan-bidding-platform that further introduced a new credit evaluation method constructed over a “credit evaluation system and method for network effect credit extension;” namely, an old and existing member may become a credit extension granting member, so now he is able to guarantee the loan of new member with his credit amount, so that a new member in urgent need of capital may become a credit extension receiving member, and he is able to get the loan that is cheaper than the no-collateral loan of an ordinary bank under the conditions of insufficient credit amount. Since the capital transaction data used between an old member and a platform is already stored in a database of a platform, and with the collateral provided by the old and existing member, so that the platform system may quickly fetch credit data, calculate guarantee amount, thus the loan-examination-granting process is speedy and efficient. As such, elder brother Henry has decided willingly and readily to become a guarantor of John, namely, he is a credit extension granting member of John, thus John is a loan applicant in “credit evaluation system and method for network effect credit extension”, as such, John is responsible for the repayment of his loan, without having to suffer from the high interest rate of no-collateral loan in the ordinary financial market.

In this manner, John applies to join in a collective-mutual-loan-bidding platform, and upon obtaining the qualification of membership after examination, John and his elder brother Henry apply together for creating a credit extension portfolio. Upon entering by Henry and John the membership data, the loan requirement of NT 300,000 and monthly repayment of around NT5,000, the system calculates and obtains the credit extension amount NT360,000 based on the loan requirement of John and the related financial data. And then, the system calculates and obtains that the platform accumulated deposit amount NT 76,400 and credit amount NT 250,000 for elder brother Henry acting as a credit extension granting member, as such the system indicates that the present overall credit extension amount for Henry is NT 326,400, that is not sufficient to guarantee the loan requirement of John, so elder brother Henry further provides a small piece of land under his name as an additional collateral. After examination, the overall credit extension amount is in excess of NT360,000, thus the system approves the creation of the credit extension portfolio of John and his elder brother Henry.

Upon completion of the above-mentioned operations, the system collects from John one-thousandth of credit extension amount as the credit extension portfolio service charge NT360 (360,000×0.001=360), and then the system allocates 50% of that amount, namely, NT 180 to elder brother John as a bonus for acting as a guarantor for John. Afterwards, the system introduces John into a 72-installment collective-mutual-loan-bidding with a monthly payment of NT 5,000. For the first month, John does not win the bidding competition, so he deposits in NT4,360. At this time, the real-time risk control & management function of the system reduces the credit extension amount that John requires and Henry has to provide to NT 355,640 (360,000−4,360=355,640). For the second, third, and fourth month, John still does not win the bidding, so he deposits in a payment amount of NT 4,400, NT4,420, and NT 4,380 respectively. Since the real-time risk control & management function of the system may control and manage the credit extension amount that the credit extension receiving member requires and the credit extension granting member must provide; therefore, at the end of the fourth month, the credit extension amount required by the credit extension portfolio of John and his elder brother is NT 342,440 (360,000−4,360−4,400−4,420−4,380=342,440). Upon winning the bidding of the platform in the fifth month with a bidding price of NT 610, John is eligible in getting altogether NT 314,130 bidding amount (5,000×4+(5,000−610)×67=314,310. Then, the system calculates and obtains that the credit extension amount used by John is NT 294,130 (314,300−5,000×4=294,130), and the guarantee revenue John has to pay to the system is NT 2,941 (294,130×1%=2,941), and after collection, this amount is allocated to elder brother Henry, namely, the credit extension granting member.

The above-mentioned bidding competition means is operated according to a bidding competition mechanism of floating interest rate capital transaction. The floating interest rate capital transaction platform is referred to as a capital-bidding mechanism that is used to establish a capital-bidding platform, so that each of the respective credit extension portfolio may proceed with bidding competition. In this bidding competition mechanism, the credit extension portfolio in the respective bidding competition portfolio multiplies the bidding payment per term by the entire payment terms in obtaining the total bidding amount required for the group applying bidding to the platform. Therefore, at the beginning of bidding competition, user in the credit extension portfolio may indicate to the platform the interest he is willing to pay for that term, and this interest is just the bidding price of bidding competition of the credit extension portfolio in the related bidding competition portfolio. Then, the floating interest rate capital transaction platform compares various bidding prices, and selects the bidding portfolio having the highest bidding price as the bidding winning portfolio for that term. The portfolios having insufficient credit amounts may participate in depositing the money, and join in a bidding competition after accumulating sufficient credit amounts; for the terms having no portfolio bidding competition, it may choose randomly a portfolio of sufficient credit amount as a bidding winning portfolio; thus the bid-winning portfolio is able to obtain a total bid amount. The calculation of total bid amount can be classified into the following two formulas depending on paying interest in advance or afterwards.
for paying interest in advance: An=(U−In)×((N−n)+(U×(n−1))
for paying interest afterwards:

$$An = ( U \times ( N - n ) ) + ( U \times ( n - 1 ) ) + {\sum }_{i = 1}^{n - 1} Ii$$

wherein
An: denotes the total bidding amount obtained for bid winner of the nth term;
U: denotes bidding payment;
N: denotes total terms;
n: denotes the present term number for the capital bidding;
In: denotes the bidding price for the nth term.

In case that the portfolio does not win in the bidding competition, then it may calculate the deposit amount based on the total bidding amount, thus earning the interest. The deposit amount calculation formulas are as follows:
for paying interest in advance: U−In
for paying interest afterwards: U
the definitions of the symbols are the same as above.

The winning portfolio must pay back the amount in the subsequent terms, the payback amount calculation formulas are as follows:
for paying interest in advance: U
for paying interest afterwards: U+In
the definitions of the symbols are the same as above.

In the above-mentioned transaction, John is able to get a loan capital that is cheaper than the ordinary no-collateral loan through the guarantee of his elder brother, thus being able to realize his life time dream; for elder brother Henry, through the application of the system, he is enabled to aid John indirectly for becoming a credit extension granting member, so that John becomes a legal debtor of a platform, thus he has to work harder to pay back the loan of the platform, hereby reducing the risk and possible loss of direct borrowing that may happen quite often between relatives and friends; for the platform itself, the guarantee loan provided by the credit evaluation system of the present invention may safeguard the right of creditor more effectively, so that it may refrain from the poor repayment rate of below 0.8% of no-collateral loan prevalent for most of the banks. As such, the present invention successfully creates a three-winner situation for capital borrowers, guarantors, and the financial platform itself.

### Embodiment 2

In this embodiment, the case of Carol is taken as an example to facilitate explanation. Carol is a kind of self-made financial expert in investment business, and in recent years, capital transaction platform is one of her major financial tools. Presently, her niece Mary is planning to study abroad, however, the 25% allowance of scholarship of a foreign university is not quite sufficient to cover all the expenses, so she has the ideas of applying for a tuition loan, but she is not able to find a suitable guarantor. Nevertheless, Mary is informed that certain capital transaction platform has just introduced “a credit evaluation system and method for network effect credit extension,” wherein, it stipulates that members of the capital transaction platform may utilize their credit amounts to become credit extension granting members, thus being able to provide guarantee for friends and/or relatives (credit extension receiving member) of insufficient credit amounts, hereby the receiving member may speedily and readily obtain capital required from the capital transaction platform that is cheaper than a no-collateral loan. Meanwhile, the credit extension granting member may therefore get a guarantee revenue of 1% of the loan. Mary is thrilled and encouraged about the information, for the guarantee revenue is very helpful in persuading the capital transaction platform big customer Carol to act as her guarantor.

Therefore, niece Mary asks an interview with her auntie Carol. Auntie Carol remembers that Mary always has a good scholastic record and is of good character and dispositions, so she has confidence in her niece Mary, besides, there is a guarantee revenue that can be earned; therefore, she readily agrees to become her niece's guarantor. Subsequently, Carol and her niece Mary apply to form a credit extension portfolio. Then, the system calculates the credit extension amount required is NT 1,168,000 based on Mary's loan requirement of NT1,200,000 and repayment term of 14 years. In addition, the system calculates and obtains that Carol's credit extension amount is NT 11,000,000 based on the various capital transaction portfolio that Carol has participated in. Since such a credit extension amount is quite enough, thus there is no need to provide additional collateral. As such, the credit extension portfolio can stand. Then, the system collects from Mary 0.2% of the amount of credit extension amount as the credit extension portfolio service charge NT 3,360 (1,680,000×0.002=3,360), wherein 50%, namely, NT 1,680 is allocated and sent to Carol as a guarantor bonus. 12 days later Mary wins the bidding and obtains a total bid amount of NT 1,235,000. At this time, the system calculates and obtains the credit extension guarantee revenue NT 12,350 (1,235,000×1%=12,350) based on the credit extension amount NT 1,235,000 used by Mary. Then, the system collects this amount from Mary and pays it to Carol.

From this time on, Carol starts actively paying attention to the financial needs of her friends and relatives that are diligent, working hard, of good character but inferior financial backgrounds. Once she is informed of their needs for loans, then she is willing to become their credit extension granting member. Thus, she may not only be able to take care of her friends and relatives, so that they may be relieved of the burdens of high interest rates of no-collateral loan, but in this process, she may also earn the guarantee revenues she deserves. Consequently, the capital transaction platforms have become very popular and are well accepted by the public for having such a good customer as Carol who is willing to provide guarantee in introducing loan applicants of superior quality.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A credit evaluation system for network effect credit extension, comprising:
a user interface, used to register data by a user in a network connection manner;
a management server, connected to said user interface and a database for proceeding with calculation, examination, determination, supervision, and execution functions; and
a database, used to provide data access as required, and it is characterized in that: more than one users realize a credit evaluation step in a capital transaction platform pre-operation by participating in said system, thus further increasing overall transaction scope of said platform.

2. The credit evaluation system for network effect credit extension as claimed in claim 1, wherein
executing necessary steps required of a credit evaluation method for network effect credit extension by making use of operation, examination, supervision, determination functions of various modules of said management server, said management server further comprises:
a credit extension portfolio application module, used to receive and temporarily store application data input by a plurality of members for creating credit extension portfolios, and loan requirements raised by members in said plurality of members desiring to be credit extension receiving members;
a credit extension amount calculation and granting module, used to fetch data of said member desiring to be a credit extension granting member and calculate an overall credit extension amount simultaneously, and calculate a credit extension amount required based on said loan requirement raised by said member desiring to be said credit extension receiving member, then compare said credit extension amount required with said overall credit extension amount, thus determining whether to create said credit extension portfolio, and deciding a final granting amount;
a real-time risk control & management module, used to calculate real-time variations of said overall credit extension amount of said credit extension granting member based on value variations of a credit extension amount source;
a credit extension amount liquidation module, used to calculate in said credit extension portfolio, a amount granting variation status of said respective credit extension granting member and a amount receiving variation status of said respective credit extension receiving member; and
a credit extension revenue calculation and issue module, used to calculate in said credit extension portfolio, a related expense required to be paid by said respective credit extension receiving member, and after collecting said related expense by said system, calculate and issue a guarantee revenue to said credit extension granting member.

3. The credit evaluation system for network effect credit extension as claimed in claim 2, wherein
in said credit extension portfolio application module, a network connection can be realized by means of a personal computer, a personal digital assistant (PDA), and a handset having wired and wireless network connection capabilities.

4. The credit evaluation system for network effect credit extension as claimed in claim 2, wherein
in said credit extension portfolio application module, said system is used to receive data of a plurality of members applying to be members of said credit extension portfolio, that includes more than one members desiring to be said credit extension granting members, and more than one members desiring to be said credit extension receiving members.

5. The credit evaluation system for network effect credit extension as claimed in claim 2, wherein
in said credit extension amount calculation and granting module, said overall credit extension amount of said member desiring to be said credit extension granting member is calculated and obtained by said system based on a sum of an amount deposited by said member in said capital transaction platform for each term, a movable and immovable property collateral provided by said member, and a credit amount obtained through credit evaluation performed by said platform.

6. The credit evaluation system for network effect credit extension as claimed in claim 2, wherein
in said credit extension amount calculation and granting module, said credit extension amount required by said member desiring to be said credit extension receiving member is a difference between said loan requirement raised by said member to said system, and an original credit extension amount calculated and obtained by said system.

7. The credit evaluation system for network effect credit extension as claimed in claim 2, wherein
in said credit extension amount calculation and granting module, in case that said overall credit extension amount of said member desiring to be said credit extension granting member is greater than or equal to said credit extension amount required by said member desiring to be credit extension receiving member, then said system determines that said credit extension portfolio can be created, meanwhile, identities of above-mentioned two members are formally converted into said credit extension granting member and said credit extension receiving member.

8. The credit evaluation system for network effect credit extension as claimed in claim 2, wherein
in said real-time risk control & management module, value variations of said credit extension amount source is calculated and obtained by said system as based on: a sum of an amount deposited consecutively in a fund-trading platform by said member for each term, value variations of said movable and immovable property collateral provided by said member, and variations of said credit amount obtained through credit evaluation and adjustment performed by said platform.

9. The credit evaluation system for network effect credit extension as claimed in claim 2, wherein
in said credit extension revenue calculation and issue module, said related expenses required to be paid by said respective credit extension receiving member include: a credit extension portfolio service charge and a credit extension guarantee revenue.

10. A credit evaluation method for network effect credit extension, that is used to provide a credit evaluation step for use by a member who desires to obtain credit evaluation amounts for participating in a capital transaction platform, so as to realize a platform pre-operation, hereby further increasing overall transaction scope of said platform, said method further comprises the following steps;
applying for a credit extension portfolio;
calculating and granting credit extension amounts;
controlling and managing risks real-time and on-line;
liquidating said credit extension amounts; and
calculating and issuing credit extension revenue.

11. The credit evaluation method for network effect credit extension as claimed in claim 10, wherein
said step of applying for said credit extension portfolio is that a plurality of members applying to said system for creating said credit extension portfolio, thus through application of said credit extension portfolio, said member desiring a loan is able to obtain speedily said credit evaluation amounts.

12. The credit evaluation method for network effect credit extension as claimed in claim 11, wherein
said plurality of members includes: more than one member desiring to be credit extension granting members, and more than one member desiring to be credit extension receiving members.

13. The credit evaluation method for network effect credit extension as claimed in claim 11, wherein
while applying to said system for creating said credit extension portfolio, said member desiring to be said credit extension receiving member must submit an application for said loan simultaneously.

14. The credit evaluation method for network effect credit extension as claimed in claim 10, wherein
said step of calculating and granting said credit extension amounts further comprises the following steps:
calculating said credit extension amount required;
calculating an existing credit extension amount of said member desiring to be said
credit extension granting member;
enhancing a credit extension;
increasing collateral provision; and
calculating an overall credit extension amount and creating said credit extension portfolio.

15. The credit evaluation method for network effect credit extension as claimed in claim 14, wherein
in said step of calculating said credit extension amount required, said system calculates a difference of a loan requirement of said member desiring to be said credit extension receiving member and an original credit extension amount as calculated by said system, said difference is said credit extension amount required by said member desiring to be said credit extension receiving member.

16. The credit evaluation method for network effect credit extension as claimed in claim 14, wherein
in said step of calculating said existing credit extension amount of said member desiring to be said credit extension granting member, said existing credit extension amount is a sum of followings: a sum of an amount deposited by said member in said capital transaction platform for respective terms, a movable and immovable property mortgage collateral provided by said member; and a credit amount obtained through credit evaluation performed by said platform.

17. The credit evaluation method for network effect credit extension as claimed in claim 14, wherein
in said step of calculating said existing credit extension amount of said member desiring to be said credit extension granting member, said system determines that whether said overall credit extension amount of said member desiring to be said credit extension granting member is greater than or equal to said credit extension amount required by said member desiring to be said credit extension receiving member, namely, if a result thus obtained is affirmative, then said system proceeds directly with said step of creating said credit extension portfolio, thus formally creating said credit extension portfolio; meanwhile, said member desiring to be said credit extension granting member formally grants said credit extension amount to said member desiring to be said credit extension receiving member through said system.

18. The credit evaluation method for network effect credit extension as claimed in claim 17, wherein
said system formally grants said credit extension amount to said member desiring to be said credit extension receiving member, meanwhile, said system formally determines said members as said credit extension granting member and said credit extension receiving member respectively.

19. The credit evaluation method for network effect credit extension as claimed in claim 17, wherein
said system determines that whether said overall credit extension amount of said member desiring to be said credit extension granting member is enough, and if a result thus obtained is negative, then said system proceeds with a credit extension enhancement step, and displaying on a user interface an inquiry asking whether to proceed with a credit extension enhancement.

20. The credit evaluation method for network effect credit extension as claimed in claim 19, wherein
in said credit extension enhancement step, said user interface displays thereon an inquiry asking whether to proceed with said credit extension enhancement, if a result thus obtained is negative, then said credit extension portfolio is not created, otherwise said system executes a collateral increase step and asks said member to increase provision of collateral.

21. The credit evaluation method for network effect credit extension as claimed in claim 20, wherein
in a collateral increase provision step, upon increasing provision of collateral by said member, said system proceeds with steps of calculating said overall credit extension amount and creating said credit extension portfolio based on said collateral increased by said member, and starts examining and calculating its credit extension amount, meanwhile, calculating said overall credit extension amount; if said amount is enough, then said system creates said credit extension portfolio, otherwise, said system displays on said user interface an inquiry asking whether to continue increasing collateral provision or not.

22. The credit evaluation method for network effect credit extension as claimed in claim 21, wherein
in said inquiry as to whether to continue increasing said collateral provision, if a result thus obtained is positive, then said member continues increasing collateral provision, otherwise said credit extension portfolio is still not created.

23. The credit evaluation method for network effect credit extension as claimed in claim 10, wherein
said system calculates real-time value variations of said credit extension amount of said member as based on: a sum of an amount deposited consecutively by said credit extension granting member into said capital transaction platform for respective terms, value variations of movable and immovable property collateral provided by said member, and credit amount variations obtained through credit evaluation & adjustment of said platform, and using it by said system as a basis in controlling and managing a risk of a credit extension amount granting, and if any insufficient conditions occur, said system can require said member to proceed with said credit extension enhancement step at any time.

24. The credit evaluation method for network effect credit extension as claimed in claim 10, wherein
in said credit extension amount liquidation step, in said credit extension portfolio, said system calculates real-time variations of amount granting of said credit extension granting member and the variations of amount receiving of said credit extension receiving member, and using them as a basis for risk control and management, and for calculating all related credit extension revenues and charges.

25. The credit evaluation method for network effect credit extension as claimed in claim 10, wherein
in said step of calculating and issuing said credit extension revenue, said system calculates and collects all related expenses said respective credit extension receiving members should pay, and wherein a guarantee expense that should be collected while granting said credit extension amount is allocated to said credit extension granting member as a guarantee revenue for granting said credit extension amount.

26. The credit evaluation method for network effect credit extension as claimed in claim 25, wherein
in calculating said expenses said respective credit extension receiving members should pay, wherein, upon creating said credit extension portfolio, said system starts calculating and collecting a credit extension portfolio service charge that said respective credit extension receiving members should pay,

27. The credit evaluation method for network effect credit extension as claimed in claim 26, wherein
in collecting a service expense by said system from said credit extension receiving member, upon collecting said service expense, said system calculates real-time a credit extension guarantee expense of a bid winning member when said member participates in said capital transaction platform and wins a bid, and after calculating and obtaining a result, collects said credit extension guarantee expense from said bid winning member, and then remits or transfers said credit extension guarantee expense to said credit extension granting member.
